(19) United States
(12) Patent Application Publication
(10) Pub. No.: US 2008/0154672 A1
(43) Pub. Date: Jun. 26, 2008

(54) PROCESS ENABLEMENT AND OPTIMIZATION SYSTEM FOR WORKERS COMPENSATION

(76) Inventor: Kevin O. Skedsvold, Atlanta, GA (US)

Correspondence Address: ATTN: E.J. ASBURY III;TAYLOR BUSCH, LLP, 1600 PARKWOOD CIRCLE, SUITE 200, ATLANTA, GA, 30339, US

(21) Appl. No.: 11/836,124

(22) Filed: Aug. 8, 2007

Related U.S. Application Data
(60) Provisional application No. 60/821,802, filed on Aug. 8, 2006.

(51) Int. Cl. G06Q 10/00

(52) U.S. Cl. 705/7; 705/1

(57) ABSTRACT

A comprehensive, computer enabled, workers compensation case management system. The system defines a plurality of participants in the workers compensation process and provides an electronic access for the participants to the system. The system documents a plurality of predetermined event flows which define the events necessary in the workers compensation process. The event flows defining a group of serial processes where a portion of the serial process occur simultaneously, or in parallel within the system. Each event defined in the system identifies a participant in the process which must act to complete the event. The event also identifies the required data, or approval, required to complete the event, and to be supplied by the participant. The system monitors, displays, and stores a status of each event within the workers compensation case, the status denoting the completion of the event. The system continuously updates the status of the events within the workers compensation case, when the identified participant provides either the required data, or approval, associated with each event. The system monitors the status of events within the workers compensation case with reference to the event flows, and electronically prompts the participant required to act in a serial process.

### CROSS-REFERENCE TO RELATED APPLICATION

This application claims the benefit of U.S. Provisional Application Ser. No. 60/821,802 filed on Aug. 8, 2006, which is herby incorporated herein by reference.

### BACKGROUND OF THE INVENTION

1. Field of the Invention

The present invention generally relates to a workers compensation case management system and method. More particularly, the present invention relates to a system and method for electronic capture of key data within the workers compensation process, to provide for a claim-centered database for process flow monitoring of the steps within the process, and for accelerating the timeframe of the process by prompting the participants as their interaction in the process is required.

2. Description of the Related Art

There is an entire industry of people, players and companies devoted to workers' compensation issues within each state. Those players include the injured workers, their Employers, the insurance companies, medical providers (including physicians of many different specialties, hospitals), the attorneys and the State Board of Workers' Compensation. With the huge number of players involved, each has his/its own vested interest in making the system work better for his/it's particular interest.

Each state has its own system of laws governing the worker compensation issues and, therefore, different rules and expectations as to how things are to be done. A brief explanation is presented on how workers' compensation law in general works and how Georgia workers' compensation law works in particular. When an Employee is injured, the Employer has the obligation to provide income and medical benefits. That obligation varies in length, expense and detail according to state law, but most workers' compensation systems operate on that premise. The Employer is obligated to provide medical treatment to the Employee to fix the problem that the injury caused. The Employer is also obligated, if the Employee is disabled, specific details of which will vary by state, to pay wage replacement benefits. The wage replacement benefits must continue until the Employee goes back to work or, in other jurisdictions, some other event occurs.

As one might expect, there is quite a bit of friction between the various interests in securing the employee return to work. The Employee may be reluctant to return to work for any number of reasons including fear of re-injury, embarrassment over the injury happening, malingering (faking it) or even resentment of the Employer or co-workers for the injury happening in the first place. The Employer/Insurer (in Georgia and most other states, the interests of the Employer and Insurer are considered to be one) want to return the Employee to work as soon as possible for any number of reasons, including saving the money paid in disability benefits, productivity issues or public relations (showing the Employees either that the Employer wants to take care of the Employees and not have them out drawing disability benefits rather than wages or in showing the other Employees that, disability benefits will not lightly be paid and then only in extraordinary circumstances when the employer decides that accommodations cannot be made to allow the employee to return to work. This is where the point of collision lies.

Each state tracks its numbers for the cost of workers' compensation claims in a number of ways, Georgia's average cost per workers' compensation claim is fairly low and ranks among the nation's lowest when the Employee does not have lost time, i.e. time away from work. Georgia's system is set up such that if an Employee misses less than 7 days of time, he or she does not get paid disability income benefits. The public policy reason for this is that an Employee who is not “truly disabled” but is capable of doing some work should return to work and his Employer should provide accommodations for him to work until his injuries are healed. Whereas Georgia's cost per claim is low when the claim is a “medical only” claim, Georgia's averages suffer once an Employee becomes entitled to income benefits.

Once an injured Employee in Georgia loses more than 7 days of time, his Employer/Insurer are obligated to commence income benefits. If the Employee is totally out of work, then the Employee receives Temporary Total Disability (“TTD” benefits). If the Employee is still working but losing income because of his injury (for example can only work 20 hours per week as opposed to the 40 hours per week worked before the injury) he is paid Temporary Partial Disability (“TPD” benefits). The last type of benefit paid to the claimant is for what is known as an impairment rating. For example, if an Employee loses a finger in a compensable work-related injury, then that Employee would be evaluated for a permanent impairment rating according to certain guidelines published by the American Medical Association.

The procedure in Georgia is that once the Employee is receiving TTD or TPD benefits, then the Employer may suspend those benefits only in certain circumstances. If the authorized treating physician says that the Employee may return to work without restrictions, then the Employer/Insurer may unilaterally suspend the benefits upon the filing of a form that provides notice to the Employee of the release. This sequence of events is referred too as the “return to work” process, and exists in varying processes in most states. If the Employee still has restricted capability to return for reasons related to his injury, then the Employer may suspend only if:
a) The Employee actually returns to work for the same or a different Employer; or
b) The Employer can provide a suitable job that has been approved by the treating physician.

The common problem for Employers/Insurers in Georgia, and in many other states, is item “b)” above. The Employer may have a job for the Employee to do and that job may be perfectly suitable for the injured worker, but until that job has been approved by the treating physician, the Employer cannot even offer the position to the Employee in the fashion that would compel the Employee to return to work. This limitation means that while the Employer is waiting to get the job approved, the Employee may collect another few weeks or months of income benefits at a time when the Employee is capable of working.

The costs to the Employer/Insurer for these impediments vary by state. Georgia's TTD rate is set at ⅔ of the average weekly wage of the Employee, but not to exceed $500 per week. If, for example, it takes the Employer 2 weeks to get a job description to the physician for consideration and an additional 2 weeks for the physician to get around to approving the job description as being a suitable job, then the Employee has received another $2,000 of money from the Employer/Insurer and has not produced anything for the Employer, or performed any additional work for this income. For the Employer and Insurer, this is simply a financial drain. For the insurance company, it represents money that they pay out on their policy and is lost as profit or as stockholder dividends. For the Employer, this money paid out affects their “Experience Rating” which means that the next time they have to get workers' compensation insurance (it is mandatory in Georgia for all businesses with more than 3 Employees) then the premium for that policy is all that much more expensive.

The interest of the Employer/Insurer is to return the Employee to work as soon as possible. The Employee, predictably, may not share that concern. Some Employees will view the prospect of returning to work as something to help the Employer and not to help them. If the injured worker is represented by an attorney, then the attorney may advise the Employee that returning to work reduces the value of their claim or settlement and that the Employee should, therefore, resist.

As noted above, if the Employer wants to discontinue the TTD benefits, they must either show that the Employee has returned to work or that the Employee has no restrictions, or they must offer the Employee a suitable job. The suitable job is to be offered to the Employee on a form known as a WC240 in Georgia. The WC240 must have attached to it the job description approved by the physician and must be served on the Employee at least 10 days prior to the date on which the Employee is to return to work. With reference to the timeline laid out above for the expected time to get a job description from the Employer and to the physician for his consideration, this means that in most circumstances, the return to work is usually delayed about 6 weeks.

On the date specified on the WC240 form, the Employee must report to work or else the Employer can suspend the TTD benefits unilaterally and without permission from the Court. If the Employee does return to work, the Employee has a grace period of 15 business days (not calendar days) to try the job. If at any time during that 15 day grace period the Employee stops working, the Employer must recommence the TTD benefits and must go to the Court to get permission to cut the benefits off. As an additional impediment, when paying, suspending or recommencing the benefits, the Form workers' comp2 is used. This form must be completed, filed with the workers' compensation Board and served on all interested parties. Often, the participants in the workers compensation process rely on memory or diary systems which provide only for pre-set reminders for a time certain for follow up to take a given action in a case. Due to the volatile nature of the timeframe for an individual case, time certain reminders are not adequate to for events and actions which must necessarily follow preceding events in different serial processes.

Having explained the competing interests and the reasons for contention within the process, it is readily apparent there is a need in the art for improvement. Accordingly, it would be advantageous to provide a workers compensation case management system and method. Such a system would enable prompt communication between the parties via electronic data transfer. The system would also allow ready review of case status by the parties in the workers compensation process. The system would also foster timely participation when required by a party to the process by automated electronic prompting dynamically generated as the status of the case progressed. Electronic forms would be utilized, and common data could be shared across the system processes by the parties. To foster the gradual adoption of the method by all parties in the process, the system would also allow a manual or scanned form to be utilized and acknowledged by the system, and the remainder of the workers compensation process would continue to be electronically enabled by the system. It is thus to such a computer enabled workers compensation case management system and method that the present invention is primarily directed.

### SUMMARY OF THE INVENTION

The disadvantages of the prior art are overcome by the present invention which, in one aspect, is a comprehensive, computer enabled, workers compensation case management system. The system includes a data storage device for storing data related to a workers compensation case, and a processing device for processing data related to the workers compensation case. The processing device and the data storage device are electronically interconnected, with the processing device able to input data too, and retrieve data from the storage device. A plurality of participants in the workers compensation process are identified within the data storage device. The system includes an electronic access device for accessing the processing device and the data storage device by the participants in the process.

A plurality of predetermined event flows are entered within the data storage device. The predetermined event flows define a plurality of events necessary in the workers compensation process. The plurality of predetermined event flows define a plurality of serial processes, wherein at least two of the plurality of serial processes may occur in a parallel process. Each event in the plurality of predetermined event flows includes the identity of a participant in the process which must act to complete the event, and also identifies either required data, or approval, associated with the event, to be supplied by the participant.

The processing device monitors, displays, and stores and retrieves from memory, a status of each event within the workers compensation case. The status of event includes the entry of the required data, or approval, associated with the event. A plurality of participants in the process may act independently and simultaneously to complete different events within the plurality of serial processes. The processing device continuously and in real time updates the status of the events within the workers compensation case, such as when the identified participant provides either the required data, or approval, associated with that event in the event flow. The processing device monitors the status of events within the workers compensation case and compares that status to the plurality of predetermined event flows. As a result, the next participant required to act in a serial process is automatically electronically prompted to provide at least one of, required data, or approval.

In another aspect of the present invention, the processing device monitors the status of events within the workers compensation case and compares that status to the plurality of predetermined event flows, wherein at least one participant in the process is automatically electronically prompted by the system when one of the serial predetermined event flows has been completed, and an electronic document required for action by the participant is generated and resides on the system. The participants in the process may include an employee, an employer, a physician, and an insurance company.

In another aspect of the present invention, each participant in the workers compensation process is assigned a unique set of access rights to the required data, or approval, related to each event contained within the system. The access rights may include the ability to view, or enter, the required data, or approval. The access rights of a participant to a particular event may change as the status of events defined within in the event flows is updated.

In another aspect of the present invention, the participants in the process may access the processing device and continuously in real time view the current status of events within the workers compensation case. The required data, or approval, associated with an event in the event flow is entered via an electronic document hosted on the system. The status of the event is then updated by the system upon completion of the electronic document. In yet another aspect of the present invention, the required data, or approval, associated with an event in the event flow is captured within the system via a text document, and wherein the status of the event is updated on the system by either the identified participant, or by the system administrator.

In another aspect of the present invention, the required data, or approval, associated with one event in the system, is automatically applied to at least one other electronic document, the other electronic document being generated within the system and associated with at least one other event in the predetermined process flow.

In another aspect of the present invention, the processing device compares the plurality of predetermined event flows to the monitored status of events within the workers compensation case, and an electronic document required for action by a next participant required to act in the serial process is generated and resides on the system.

In another aspect of the present invention, each participant in the workers compensation process is assigned a unique set of access rights at each event in the process to the electronic documents generated by the system. The access rights may include the ability to view, or modify the electronic document. The access rights of a participant to a particular electronic document on the system may change as the status of events defined within the predetermined event flows is updated. The required data, or approval, associated with an event in the event flow is entered in the electronic document hosted on the system, and the status of the event is updated by the system upon completion of the electronic document.

In another aspect, the invention provides a method of enabling the management and completion of the workers compensation process. The invention includes the steps of providing a data storage device for storing data related to a workers compensation case, providing a processing device for processing data related to the workers compensation case. The processing device and the data storage device being electronically interconnected, the processing device being able to input data too, and retrieve data from the storage device.

The method includes the step of identifying a plurality of participants in the workers compensation process within the data storage device, and providing an electronic access device for accessing the processing device and the data storage device, by the participants in the process. Defining a plurality of predetermined event flows within the data storage device, the event flows include a plurality of events necessary in the workers compensation process. The plurality of predetermined event flows include a plurality of serial processes, wherein at least two of the plurality of serial processes may occur at the same time within the method in a parallel process.

The method includes the step of defining for each event in the plurality of predetermined event flows the identity of a participant in the process which must act to complete the event, and identifying either required data, or approval, associated with the event, to be supplied by the participant. Monitoring, displaying, and storing a status of each event within the workers compensation case, the status of the event including the entry of the required data, or approval, associated with the event. The system provides access to the participants in the process to continuously and in real time view the current status of the events within the workers compensation case.

The method includes the processing device continuously and in real time updating the status of the events within the workers compensation case, when the identified participant provides either the required data, or approval, associated with that event in the event flow. The processing device then compares the plurality of predetermined event flows to the monitored status of events within the workers compensation case and, automatically electronically prompts a next participant required to act in a serial process to provide at least one of, required data, or approval.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE DRAWINGS

FIG. 1 is an illustration of the workers compensation process including the participants in the process.

FIG. 2 is an illustration and comparison of the typical workers compensation return to work process and the return to work process as enabled by the present invention.

FIG. 3 is an illustration of the workers compensation process as enabled by the present invention.

FIG. 4 is an illustration of the events which must occur during the reporting of a worker injury in the State of Georgia.

FIG. 5 is an illustration of the initial events that must occur in the Medical Treatment of an Injured Worker in the State of Georgia.

FIG. 6 is an illustration of a series of events that must occur in precise order based on actions taken by different parties, in different serial processes, during the workers compensation process.

### DETAILED DESCRIPTION OF THE INVENTION

The system and method applies a web based, computer enabled system to increase the efficiency, speed, and robustness of the workers' compensation process. The system automates what is now a manual process in most states. The system and method enables electronic document capture and transfer between the different parties, workflow management, process visibility, and timely communications within the workers compensation process. The system and method of the present invention is explained in the context of the Georgia Workers' compensation process. However, the invention is not limited processes peculiar to Georgia Law and will vary based upon individual state statutory schemes, rules, forms and processes. As will be appreciated by those skilled in the art, the inventive aspects as taught by the system and method may be applied to benefit any state workers' compensation procedure or situation.

The benefits of the system to the various parties involved differ depending upon which role the users occupy. For the Employers and Insurers, one benefit would be that the process of job approvals and therefore job offers can be conducted electronically, cutting weeks and possibly months off the approval/offer process. For the Employer/Insurer, this means money saved on disability benefits, a more productive work force and lower experience ratings at renewal time of the Employer's workers' compensation policies. For the medical provider, one benefit is speeding up payment for charges incurred in treating a workers' compensation patient, as well as better communication with the Insurer to secure approval for necessary treatment.

The system and method utilize a computer program running on a computer processor. The processor has a central processing unit, random access memory, read only memory, various data and communication busses, and electronic input/output means as are well known to those skilled in the art. The computer processor may be a single unit, or may be an electronically interconnected system of processors. The computer program to enable the present invention may be coded in any convenient programming language such as java, html, or other language as are readily known to those skilled in the art.

The data associated with the system and method is stored on a data storage device. The data storage may be integral with the processing unit, or may be at a remote location and electronically interconnected to the processing unit. The data stored in the device will include the name, address, professional license or accreditation number, and other information required in identifying the parties as required by the individual states workers compensation process. The data stored in the storage device will also include information as entered by the participants in the process, for example the diagnosis of the treating physician may be entered as electronic text within the system, the approval or denial of a treatment plan by the insurance carrier, which may take the form of a yes or no toggle, or other data as is required to be entered in the individual states workers compensation process. The processing unit and data storage device operating together form the central computer server.

In one embodiment of the present invention, the electronic connection between the components of the workers compensation system, such as between the processor, the data storage device, and the participants in the workers compensation process occurs over a global computer network, otherwise known as the internet. The participant access and interaction with the system is via a common web browser such as Internet Explorer®, or via other web browser applications as are readily known to those skilled in the art. In alternative embodiments of the present invention, some components of the system may be connected via a local intranet, via a dedicated hardwire, or via other computer interconnect means as are readily known to those skilled the arts. In other alternative embodiments of the present invention, participants in the process may access the system via an intranet, via phone, via a direct hardwire connection to the processor or via other computer access means as are readily known to those skilled the arts. For example, the system administrator may often directly access the processing unit and data storage device from a local terminal.

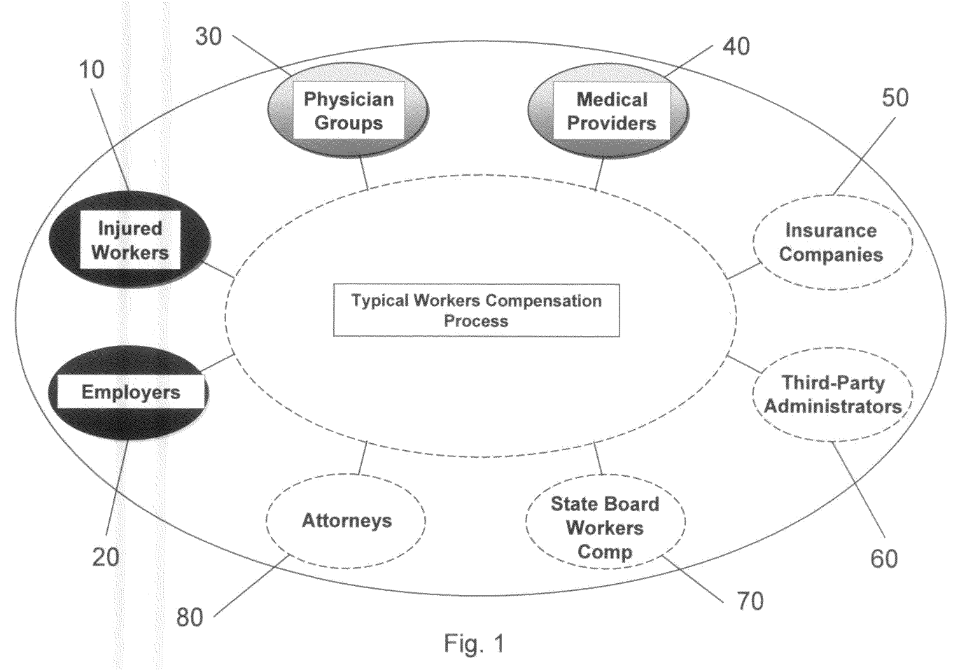

With reference to the figures in which like numerals represent like elements throughout, FIG. 1 is a depiction of the workers compensation process as is common in most states. The parties to the workers compensation process include the injured worker 10, employer 20, physician groups 30, medical providers 40, insurance companies 50, third party administrators 60, the state workers' compensation board 70, and attorneys 80. As depicted in FIG. 1, many parties must interact in the workers compensation process, and often the action of the parties must take place in a defined sequence.

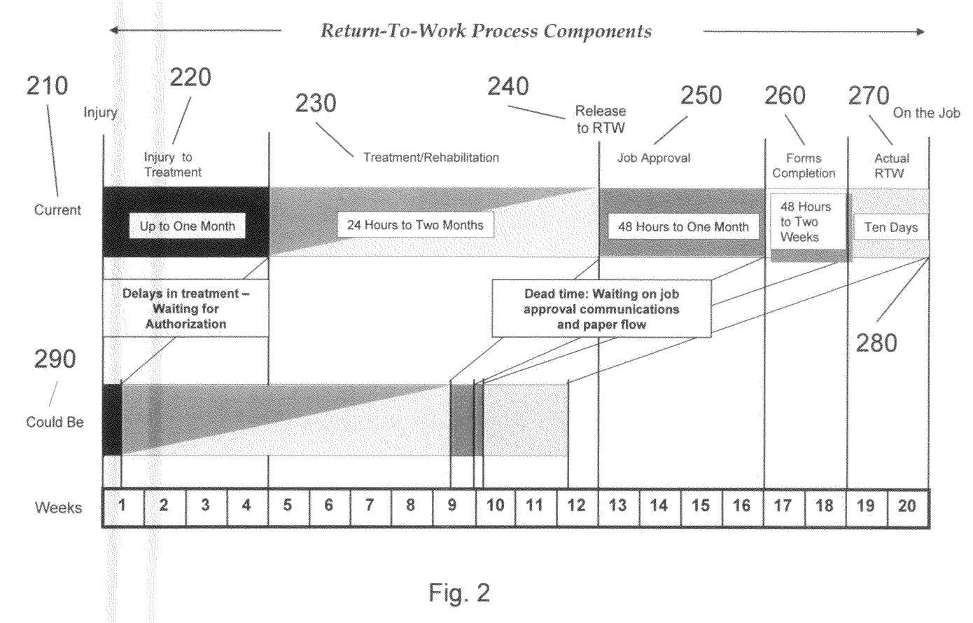

As depicted in FIG. 2, the typical workers compensation return to work process timeline can extend for many weeks. Line 210 depicts an exemplary workers compensation sequence of events. At 220 the worker reports to a treating physician, and then must wait for the treatment to be authorized by the workers compensation insurance company. At 230 the physician group and other medical providers treat the injured worker. At 240 the injured worker is authorized to return to work in some capacity. At 250, a job is recommended for the injured employee by the employer, which must then be approved by the treating physician. At 260, the forms required to return the employee to work are completed by the employer and physician. At 270, the worker is typically given advance notice prior to returning to work. The notice period is statutorily defined and will vary by state, and is depicted here as 10 days. Finally, at 280 the injured worker returns to work in some capacity.

A more optimized return to work process is presented in line 290. In the optimized process, the delays in waiting for treatment authorization, waiting for job approval communications and paper flow have been reduced. The optimized process of the present invention uses an automated system of electronic form capture and submission, workflow management within the workers compensation process, process visibility where the participants in the process may readily view the status of process events, and timely communication enabled by electronic document exchange and the prompting of participants when their action is required. The process cycle time is compressed by removing paper handling, automating communication between the parties in the process, and monitoring the events and activities required in the process. In the example as depicted in FIG. 2, the optimized process and method reduces the time required to return the employee to work from approximately 20 weeks, down to a more efficient 12 weeks.

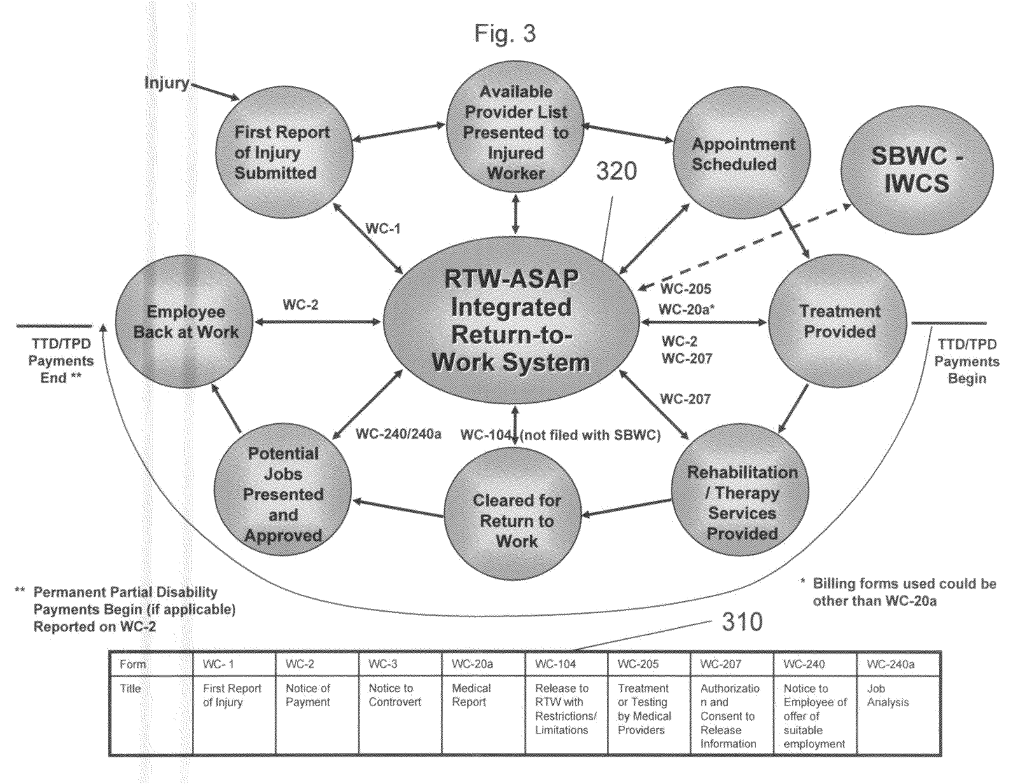

As depicted in FIG. 3, the system and method of the present invention enables electronic communication between the parties in the workers compensation process. FIG. 3 depicts a table of forms 310 which must be completed in the various steps of the workers compensation process of the State of Georgia. Other states will have a similar burden of forms which must be timely completed by one participant in the process and then forwarded to another participant in the process. As further depicted in FIG. 3, the State Board of Workers Compensation (“SBWC”) may also participate in the process. The system and method changes the traditional workers compensation process from a group of disparate events linked only by a paper trial, to a system managed process linked through a common repository of case information 320. The participants may then readily exchange electronic information as required in the process, may readily view information or data resident in the system, and may readily view the current status of each step or event in the workers compensation process. All of the information exchange, data review, and status review occur in real time on the system. Any change in the status of an event, for example the completion of a required form by a participant, or the acceptance of treatment recommendation by an insurance provider, is continuously updated on the system in real time, and is immediately available for viewing by the other parties in the process.

In another embodiment of the present invention, the data within the central processing system includes a required flow path for the steps, or events, within the workers compensation process. Many of the events within the workers compensation process must occur in a serial fashion. Stated another way, each event in the process must be completed before the next event in the process may be executed.

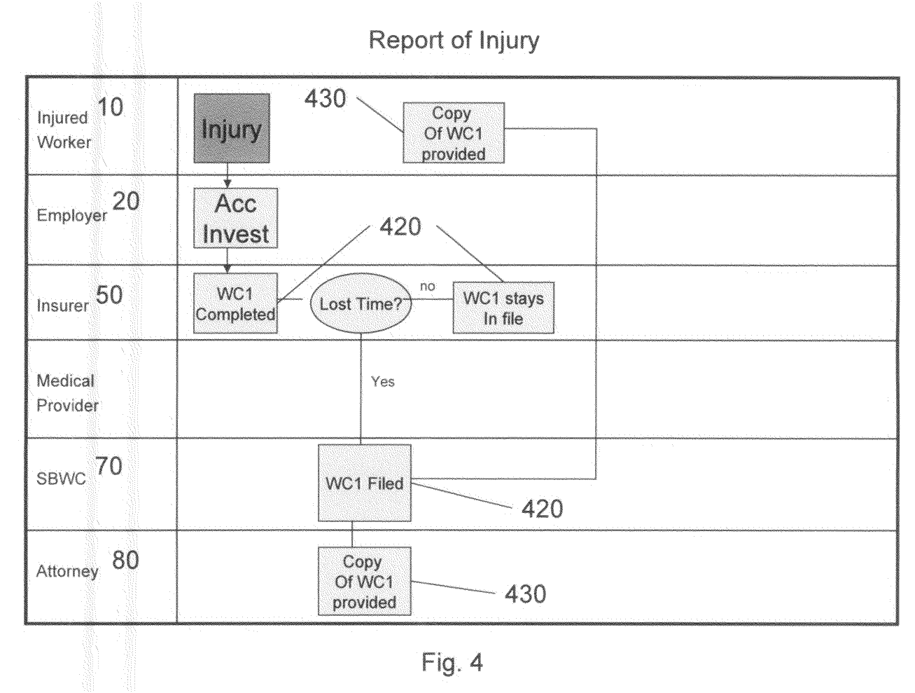

FIG. 4 is a depiction of the events which must occur during the reporting of a worker injury in the State of Georgia. Each party in the workers compensation process has a row on the left side of the figure. The Injured Worker 10 must first report the injury 410. The Employer 20 must then notify the Insurer 50. The Insurer 50 must then complete workers comp form WC1 420 to report the injury. The Insurer 50 must then take one of two actions. If the Injured Worker 10 has lost more than seven days of work, the Employer 20 is obligated to provide workers compensation and the WC1 420 form is filed with the State Board of Workers Compensation 70 (“SBWC”). The SBWC 70 then provides copies 430 of the WC1 form 420 to the Injured Employee 10, and to the Attorney 80. If the Injured Worker 10 has not lost more than seven days of work, the WC1 form 420 is filed at the Insurer.

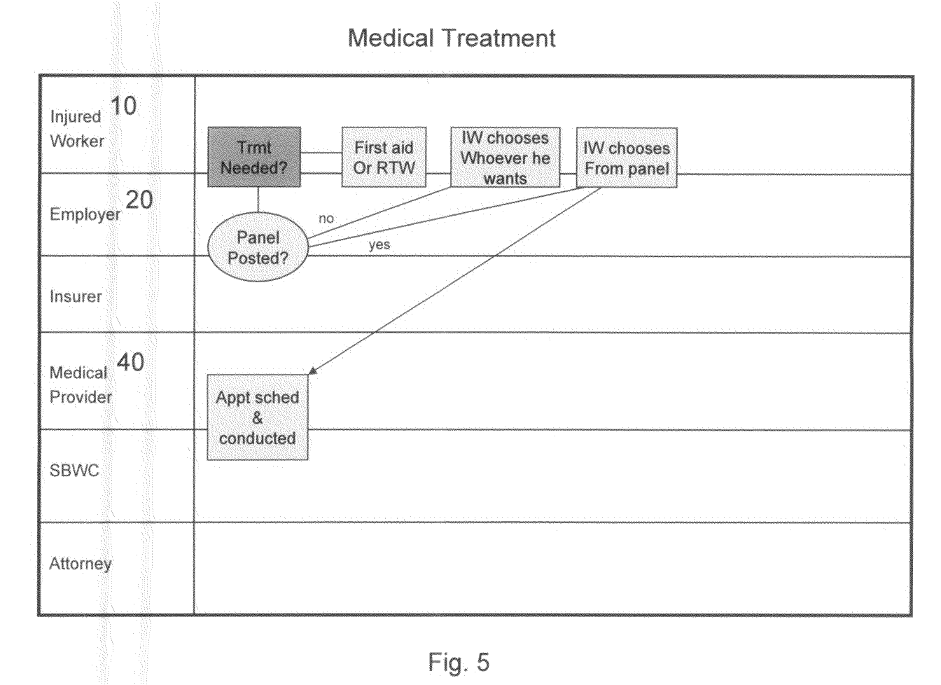

FIG. 5 is a depiction of the initial events that must occur in the Medical Treatment of an Injured Worker 10 in the State of Georgia. After an injury, the Injured Worker first requests treatment to the Employer 20. The Employer 20 may then post a worker's compensation panel 510. If the Employer 20 has posted a panel 510, the Injured Employee 10 must choose a Medical Provider from the panel. If the Employer has not posted a Panel 510, the Injured Employee may choose his Medical Provider 40. In either case, an appointment for treatment is schedule with the Medical Provider 40.

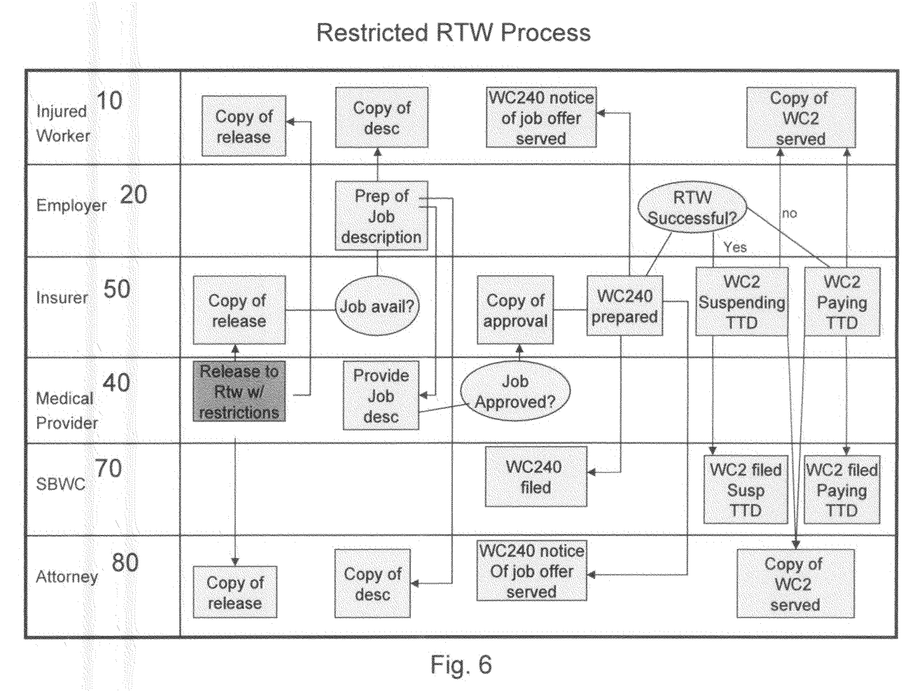

FIG. 6 is an illustration of a series of events that must occur in a precise order based on actions taken by different parties, in different serial processes, during the workers compensation return to work process. In this simplified illustration of the process, all participants must interact with multiple other participants during the execution of multiple serial processes.

As seen in FIGS. 4, 5 and 6, the workers compensation process may be viewed as a combination of interdependent serial processes. In FIG. 5, we have the serial process for the Injured Worker 10 to obtain medical treatment from a Medical Provider 40. In FIG. 4 we have the initial serial process from the injury to the determination of time lost by the Injured Worker 10. Based upon the determination of time lost by the Injured Worker 10, the process flow will branch onto one or another additional serial processes. Serial processes are also involved in the medical authorization request process, the medical billing cycle, return to work consideration for the injured employee, and the restricted return to work process, when the employee may perform limited or restricted jobs.

The serial processes of FIGS. 4, 5 and 6, must be occurring at the same time in an efficient workers compensation system. When viewed in the context of the entire system, the individual serial processes occur in a parallel fashion, or parallel process, across the worker compensation system. Stated another way, many individual serial processes are occurring at the same time within the system. At discrete points in the workers compensation system, individual serial processes share a common event with another serial process. Often one serial process cannot continue until the other serial process has arrived at the event, and the status of the event has been determined. An example of this type of event is the preauthorization request for medical treatment. The serial process of treatment of the injured worker may not proceed until the medical treatment request is authorized by the insurer. However, the medical treatment request may be authorized, and forms forwarded to the SBWC and the Attorney, prior to treatment actually being conducted on the injured employee.

The efficient operation of the system as a whole requires that each serial process proceed as quickly as possible, and that each process be monitored for timely completion of the next event in the process. A failure of one party in the workers compensation process to take action to move a serial process forward, may often block the completion of multiple other serial processes. The system and method of the present invention include an event flow registry, or event flow path, for each identified serial process. Each event is assigned a status which denotes if the event has been completed, by the entry of required data, or by approval, or non-approval of the party associated with the event. The status of each event within the event registry is monitored and continuously updated in real time. For each serial process, and for the workers compensation process as a whole, the event flow and status of each event is visible to the parties on the central computer system, and is therefore easily monitored. Electronic prompting forwarded to the next party to take action in the serial event process enables a more rapid completion of each serial flow. At points in the system where two serial processes share a common event, additional prompting may be employed, or the party to the event may be given advance notice, or pre-prompting, that the serial process is approaching being ready for his interaction. Such advance notice would automatically occur in such events as notification to the employee, employer and insurer of upcoming medical appointments, requests for treatment authorization and reminders of pending authorization requests.

In another embodiment of the present invention, the system enables electronic document transfer between the parties. The documents may be viewed, completed, edited, copied, and signed or executed via the central computer server as accessed via the global computer network. The system provides a readily customized graphical user interface “wrapper” around the documents associated with a workers' compensation process, while maintaining the documents electronically. Each participants in the process may individually configure the appearance of their point of entry to the system, or dashboard, to maximize the ability of that user to access, view and sort data relevant to that user's need for system information, hence the document wrapper may be customized for each party in the process.

The documents may be transferred between the parties electronically via the central computer server. The documents may also be transferred by traditional means such as via E-mail, Fax, U.S. Mail where required, or any combination of electronic and traditional means. In another alternative embodiment of the present invention, the system enables the electronic signature or execution of documents within the process, and thus avoids or minimizes any conventional mail or fax delays, and receipt questions. The electronic signature may be entered upon access to the system by the party, or may be entered in an electronic document as forwarded by the system to the party, or by other methods as are known to those skilled in the art.

In another alternative embodiment of the present invention, the system provides an electronic reminder, or tickler, to the next party required to take action in the workers' compensation process. The tickler is generated when the process is completed to a defined point, wherein action by the notified party is required or expected. Each defined point within the process may be viewed as a process event, and the status of the event, as either completed of pending, may be tracked and monitored. An electronic reminder may also be forwarded to parties in the process reminding of milestone dates, pending future milestone dates, status checks, inquiries with other parties in the process, or any other reminder which may facilitate the efficient and rapid flow of the workers' compensation process.

In another alternative embodiment of the present invention, the parties using the system are assigned different access rights. Each access rights class is as appropriate to allow viewing of only a portion of the data resident in the system as required for the needs and role of that party in the process. The access rights for each party may change as the status of the case moves from one point to another in the workers' compensation process. For example, the medical records of the patient, including the diagnosis by the treating physician, are subject to strict privacy laws. Many state statutory schemes, however, provide that when submitting a claim for workers' compensation benefits, an employee is deemed to have waived the right to privacy for that condition as to his employer, the Employer's workers' compensation insurer and their representatives. The invention contemplates that waiver while protecting the employee's information from disclosure to individuals not statutorily entitled to receive, review or handle that data. The medical records may be viewed or utilized within the system by authorized parties when a required patient release is present within the system. Prior to the entry within the system of the executed patient release, the privacy laws may require that no parties view the patient data provided by the treating physician without specific authorization. Another example of dynamic access rights is the access rights assigned to the Attorney for the Employee. The Employer or Insurer may ensure that access to confidential employee information may be achieved only when the Employee has confirmed representation by specific counsel and that representation has been submitted to the Employer or Insurer and where the proof of representation resides on the system. As will be appreciated by those skilled in the arts, the implementation of the document control and party rights within the system may be customized to conform to the applicable state law for each workers' compensation claim.

In another alternative embodiment of the present invention, the system allows electronic data to be shared across events in the process, and thus avoids redundant data entry of information. For example, the patient information of the injured Employee from the treating physician may be entered into the system and electronically transferred to other parties within the process who are authorized, and have a requirement to view such data. The relevant data may also be automatically copied or applied within other documents within the system as applicable. Error detection and control may also be implemented in the system wherein data from multiple electronic documents, as generated by different participants in the process, may be compared and if necessary any discrepancies resolved.

The system and method will provide a centralized database of claims documents, forms and medical records that will allow for later added participants, such as a new attorney for the employee or a new treating physician, to have immediate access to those documents extant prior to involvement and relevant to continued handling of the claim. Immediate access to such information, including but not limited to medical narratives and actual digital copies of diagnostic films will allow parties, most especially the medical provider to make intelligent and informed decisions which will facilitate prompt, professional and accurate decision-making.

In yet another alternative embodiment of the present invention, the system and method automatically generates and forwards documents to parties in the process, when sufficient data has been entered into the system. Stated another way, the documents may be automatically generated and forwarded when the events in the process have reached a status allowing, or requiring, the documents to be forwarded. One example of this is the forwarding of bills from the treating physician to another health care provider of the Employer. The system provides a readily available and standardized document set to be applied in each workers' compensation case. In so doing, the current invention may eliminate the need for duplication of claims documents and mailing or faxing of records between parties thus eliminating delay, expense and possible miscommunication.

In yet another alternative embodiment of the present invention, the system may allow the entry and storage of a scanned original paper document. The paper documents may be reside in system in various universal file formats, such as Adobe® Acrobat®, or in other file formats as are readily known to those skilled in the arts. Most computer users are familiar with pdf documents and since pdf documents may be “read-only” they cannot be altered by recipients of the information.

Upon entry of a scanned document into the system, the appropriate toggles are set within the system architecture to note the capture of the document and data within the system, and thus allow the process to continue forward electronically. In this manner, the workers' compensation process may be implemented in the system using a hybrid of intelligent electronic documents created and populated within the system, and scanned copies of documents created external to the system, with the appropriate data, or approvals entered by an authorized user, or system administrator, to make the system aware of the entry of the scanned external document. The system may then reflect the status of the event in the process as completed.

The system and method of present invention encourages and directly benefits the parties to the workers compensation process. For the Employer, the system will involve having a database of jobs in their operation already available for review and approval so that the physician can view them while the most recent office visit of the Employee is still fresh in the physician's mind. The system and method may utilize a vocational rehabilitation specialists whose role is to conduct a job analysis, secure digital photos of the job in operation and have those analyses and photos available on the system site for the physician to review.

In operation, if the job is available at the time of the Employee visit, the physician can look at the system website while the patient is still in the office and issue his approval of a particular job. In another embodiment of the present invention, the system would be designed so that when the physician indicates his approval of a position, the approval is sent to the Employer and the Insurer in an email automatically generated for this specific purpose. The Employer and the Insurer can then, upon opening the email, visit the system website to review the job approval, and be prompted to complete a WC240 form for immediate action on return to work efforts. This will eliminate delays occasioned by physician inattention to later provided job descriptions and will allow immediate comparison of employee condition to the physical requirements of the proposed occupation/task/job description and foster better communication with the employee. Further, immediate consideration of job tasks for suitability to the employee's restricted capacity will foster earlier return to work as approvals will automatically be made available to parties and quicker action can be taken to implement form completion and job offer.

Within the next year the Employer or Insurer can file this electronically with the workers' compensation board when the workers' compensation board system is configured to accept electronic filings. The workers' compensation form may be auto-filled based upon information in the system such as patient's name, patient's Employer, job description approved, etc. The workers' compensation boards of the various agencies may, or may not, be set up to accept electronic filing of documents. By automatically generating the notification email to the Employer and Insurer, and applying the data resident in the system, or auto-filling the required form upon request, the time-lag between the medical appointment and the job offer may be reduced dramatically, and the total funds paid out in income benefits is lessened.

The participation of the treating physician is important in this web-centered process and method. Until the physician's data is entered, the process may be stalled, or may make only limited progress. The system and method provides important benefits to the treating physicians which encourages their participation. For the treating physicians in Georgia, there are two major complaints about the Georgia workers' compensation system. First, the time that it takes to secure payment for medical services is too long. Second, the process to secure approval for a procedure, a medical device (back brace, TENS unit, etc), service (such as physical therapy), diagnostic test (Xray, MRI, nerve conduction study) is too long and requires too much time invested on the part of their staff. The system and method central computer server, and website of the present invention addresses both of those concerns, and therefore entices the physicians to use the system.

The system and method also speed up the process of the payment of physicians' bills. The Employer/Insurer do not have to pay a bill until the physician provides them with the bill, on one of three specific forms, along with the office note that supports that bill. Once both of these items have been provided, the Employer/Insurer have 30 days to pay. By emailing bills and records to the Employer/Insurer, with sufficient proof maintained by the system that the bill was sent and received, the physician can speed the time when the money for these charges is received in his office.

As to the procedure approval process, physicians complain that they spend too much time on the phone, leaving messages, etc., trying to get permission to do something for the patient. The Georgia workers' compensation board attempted to address this problem with the introduction of the WC205 form. The WC205 form contemplates service by fax or email and would be completed by the physician. The advantage of the form to physicians is that once served, the Employer/Insurer must respond within 5 days or the request is deemed by law to have been authorized. Most physicians are not, however, familiar enough with the form to properly apply it. The system and method of the present invention are designed to make the form more widely available, meaning that one of the main irritants for the physician can be removed. As may be appreciate to those skilled in the art, the authorization requirements will vary by state and the system process may be conformed to each state's statutory scheme.

In operation, the system will provide the WC205 form available on a website for auto-filling based upon data input by the physician. The identifying information and the requested procedure may then be emailed to the Employer/Insurer for their review and approval or rejection. In other words, by giving the physician some incentive to use the system for his benefit, he is drawn into a system that ultimately benefits the Employer/Insurer regarding return to work issues. Since many physicians are now going to electronic management of their databases anyway, producing records and bills via email should be all the easier to accomplish. The system and method also anticipate that the physician may not want to fill out the billing forms online but may instead want to attach a copy of the form that they already use to an email. These documents may be accepted into the system as a text documents.

For the Insurer, there is always a concern over the mountain of paperwork on each adjuster's desk. These personnel sometimes have as many as 200 active cases on their desks which require response, action, strategy, and work. With so much work, the Insurer personnel cannot possibly maintain focus on all of the facts and problems associated with each case. The onerous workload often results in missed opportunities to file a particular form, to suspend benefits, or to return an injured Employee to work at the earliest possible date. By having the system and method of the present invention, that prompts the Insurance adjuster to take advantage of an opportunity, and automates the task required with an electronic form and a graphical user interface, the adjuster can be more efficient and proficient at a job that is often characterized by running from emergency to emergency.

Current workers compensation claims systems and processes do not contemplate active Employee involvement. The Employee is viewed as a passive actor whose input is limited to acting as required by medical necessity and or employer/insurer direction. The system and method of the present invention will make the Employee an active participant in the process. The Employee will have secure access to his claim information and can, at a glance, secure information concerning his treatment, requested testing, approvals by the employer/insurer to requests made by the medical provider. The Employee will have 24/7 access to that information and will not be limited to receiving information from parties during normal business hours. The invention will further allow employee access to the Employer designated physicians approved as authorized treating physicians by that employer.

This embodiment of the invention represents an improvement over current art, technology in that it allows the injured worker online access to claims documents not heretofore allowed due to concerns by the Employer or Insurer of unauthorized access to confidential Employer/Insurer financial data. By maintaining a claim centered database separate and distinct from Employer or Insurer databases, confidential Employer/Insurer notes, calculations and financial data is preserved. By providing immediate access to employee's medical records, to medical appointment notifications as well as other claim information, the need for constant telephone or mail contact with an employee is minimized thus saving man-hours on the part of the Employer and Insurer. Such access will further save time and expense by eliminating the requirement on the part of the Employer or Insurer to copy and provide ongoing record requests to the Employee, often required to be provided free of charge.

The system and process of the present invention has been presented in the context of that required in the State of Georgia. The various states of the U.S. may require different events in the workers compensation process. As may be readily appreciated by those skilled in the art, the system and process of the present invention may be customized to adhere to each U.S. state's requirements in the workers' compensation process.

While there has been shown a preferred embodiment of the present invention, it is to be understood that certain changes may be made in the form and arrangement of the process elements and steps for the optimization of the workers' compensation process without departing from the underlying spirit and scope of the invention.

What is claimed is:

1. A comprehensive, computer enabled, workers compensation case management system comprising:
a data storage means for storing data related to a workers compensation case;
a processing means for processing data related to the workers compensation case;
wherein the processing means and the data storage means are electronically interconnected, the processing means able to input data too, and retrieve data from the storage means;
wherein a plurality of participants in the workers compensation process are identified within the data storage means;
a electronic access means for accessing the processing means and the data storage means by the participants in the process;
wherein a plurality of predetermined event flows are entered within the data storage means, the predetermined event flows comprising a plurality of events necessary in the workers compensation process, the plurality of predetermined event flows comprising a plurality of serial processes, wherein at least two of the plurality of serial processes may occur in a parallel process;
wherein each event in the plurality of predetermined event flows comprise the identity of a participant in the process which must act to complete the event, and identifies either required data, or approval, associated with the event, to be supplied by the participant;
wherein the processing means monitors, displays, and stores and retrieves from memory, a status of each event within the workers compensation case, the status of event comprising the entry of the required data, or approval, associated with the event;
wherein a plurality of participants in the process may act independently and simultaneously to complete different events within the plurality of serial processes;
wherein the processing means continuously in real time updates the status of the events within the workers compensation case, when the identified participant provides either the required data, or approval, associated with that event in the event flow; and
wherein the processing means compares the plurality of predetermined event flows to the monitored status of events within the workers compensation case, and the system automatically electronically prompts a next participant required to act in a serial process to provide at least one of, required data, or approval.

2. The comprehensive, computer enabled, workers compensation case management system of claim 1, wherein the processing means monitors the status of events within the workers compensation case and compares that status to the plurality of predetermined event flows, wherein at least one participant in the process is automatically electronically prompted by the system when one of the serial predetermined event flows has been completed, and an electronic document required for action by the participant is generated and resides on the system.

3. The comprehensive, computer enabled, workers compensation case management system of claim 1, wherein the participants in the process comprise an employee, an employer, a physician, and an insurance company.

4. The comprehensive, computer enabled, workers compensation case management system of claim 1, wherein each participant in the workers compensation process is assigned a unique set of access rights to the required data, or approval, related to each event contained within the system.

5. The comprehensive, computer enabled, workers compensation case management system of claim 4, wherein the access rights comprise the ability to view the required data, or approval.

6. The comprehensive, computer enabled, workers compensation case management system of claim 4, wherein the access rights comprise the ability to enter the required data, or approval.

7. The comprehensive, computer enabled, workers compensation case management system of claim 4, wherein the access rights of a participant to a particular event change as the status of events defined within in the event flows is updated.

8. The comprehensive, computer enabled, workers compensation case management system of claim 1, wherein participants in the process may access the processing means and continuously in real time view the current status of events within the workers compensation case.

9. The comprehensive, computer enabled, workers compensation case management system of claim 1, wherein the required data, or approval, associated with an event in the event flow is entered via an electronic document hosted on the system, the status of the event being updated by the system upon completion of the electronic document.

10. The comprehensive, computer enabled, workers compensation case management system of claim 1, wherein the required data, or approval, associated with an event in the event flow is captured within the system via a text document, and wherein the status of the event is updated on the system by either the identified participant, or by the system administrator.

11. The comprehensive, computer enabled, workers compensation case management system of claim 1, wherein the required data, or approval, associated with one event in the system, is automatically applied to at least one other electronic documents, the other electronic document being generated within the system and associated with at least one other event in the predetermined process flow.

12. A comprehensive, computer enabled, workers compensation case management system comprising:
a data storage means for storing data related to a workers compensation case;
a processing means for processing data related to the workers compensation case;
wherein the processing means and the data storage means are electronically interconnected, the processing means able to input data too, and retrieve data from the storage means;
wherein a plurality of participants in the workers compensation process are identified within the data storage means;
a electronic access means for accessing the processing means and the data storage means by the participants in the process;
wherein a plurality of predetermined event flows are entered within the data storage means, the predetermined event flows comprising a plurality of events necessary in the workers compensation process, the plurality of predetermined event flows comprising a plurality of serial processes, wherein at least two of the plurality of serial processes may occur in a parallel process;
wherein each event in the plurality of predetermined event flows comprise the identity of a participant in the process which must act to complete the event, and identifies either required data, or approval, associated with the event, to be supplied by the participant;
wherein the processing means monitors, displays, and stores and retrieves from memory, a status of each event within the workers compensation case, the status of event comprising the entry of the required data, or approval, associated with the event;
wherein a plurality of participants in the process may act independently and simultaneously to complete different events within the plurality of serial processes;
wherein the processing means continuously in real time updates the status of the events within the workers compensation case, when the identified participant provides either the required data, or approval, associated with that event in the event flow; and
wherein the processing means compares the plurality of predetermined event flows to the monitored status of events within the workers compensation case, wherein an electronic document required for action by a next participant required to act in the serial process is generated by and resides on the system.

13. The comprehensive, computer enabled, workers compensation case management system of claim 12, wherein the participants in the process comprise an employee, an employer, a physician, and an insurance company.

14. The comprehensive, computer enabled, workers compensation case management system of claim 12, wherein each participant in the workers compensation process is assigned a unique set of access rights at each event in the process to the electronic documents generated by the system.

15. The comprehensive, computer enabled, workers compensation case management system of claim 14, wherein the access rights comprise the ability to view the electronic document.

16. The comprehensive, computer enabled, workers compensation case management system of claim 14, wherein the access rights comprise the ability to modify the electronic document on the system by entering required data, or approval.

17. The comprehensive, computer enabled, workers compensation case management system of claim 14, wherein the access rights of a participant to a particular electronic document on the system change as the status of events defined within the predetermined event flows is updated.

18. The comprehensive, computer enabled, workers compensation case management system of claim 12, wherein participants in the process may access the processing means and continuously in real time view the current status of events within the workers compensation case.

19. The comprehensive, computer enabled, workers compensation case management system of claim 12, wherein the required data, or approval, associated with an event in the event flow is entered in the electronic document hosted on the system, and the status of the event is updated by the system upon completion of the electronic document.

20. A method of enabling the management and completion of the workers compensation process comprising the steps of:
providing a data storage means for storing data related to a workers compensation case;
providing a processing means for processing data related to the workers compensation case, the processing means and the data storage means being electronically interconnected, the processing means being able to input data too, and retrieve data from the storage means;
identifying a plurality of participants in the workers compensation process within the data storage means;
providing an electronic access means for accessing the processing means and the data storage means by the participants in the process;
defining a plurality of predetermined event flows within the data storage means, the predetermined event flows comprising a plurality of events necessary in the workers compensation process, the plurality of predetermined event flows comprising a plurality of serial processes, wherein at least two of the plurality of serial processes may occur in a parallel process;
defining for each event in the plurality of predetermined event flows the identity of a participant in the process which must act to complete the event, and identifying either required data, or approval, associated with the event, to be supplied by the participant;
monitoring, displaying, and storing a status of each event within the workers compensation case, the status of the event comprising the entry of the required data, or approval, associated with the event;
providing access on the system to the participants in the process to continuously and in real time view the current status of the events within the workers compensation case;
the processing means continuously in real time updating the status of the events within the workers compensation case, when the identified participant provides either the required data, or approval, associated with that event in the event flow; and
the processing means comparing the plurality of predetermined event flows to the monitored status of events within the workers compensation case and, the system automatically electronically prompting a next participant required to act in a serial process to provide at least one of, required data, or approval.
